(19) United States
(12) Patent Application Publication
(10) Pub. No.: US 2009/0136785 A1
(43) Pub. Date: May 28, 2009

(54) Methods for nanopatterning and production of magnetic nanostructures

(75) Inventor: Jian Chen, Mountain View, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: NANOSYS, Inc., Palo Alto, CA (US)

(21) Appl. No.: 12/285,635

(22) Filed: Oct. 9, 2008

Related U.S. Application Data
(63) Continuation-in-part of application No. 12/003,965, filed on Jan. 3, 2008.
(60) Provisional application No. 60/878,342, filed on Jan. 3, 2007.
(60) Provisional application No. 60/906,824, filed on Mar. 14, 2007.

(51) Int. Cl. G11B 5/706; B44C 1/22

(52) U.S. Cl. 428/846; 216/22

(57) ABSTRACT

Methods for nanopatterning and methods for production of nanoparticles utilizing such nanopatterning are described herein. In exemplary embodiments, masking nanoparticles are disposed on various substrates and to form a nanopatterned mask. Using various etching and filling techniques, nanoparticles and nanocavities can be formed using the masking nanoparticles and methods described throughout.

### CROSS REFERENCE TO RELATED APPLICATIONS

The present application is a continuation-in-part of currently pending U.S. patent application Ser. No. 12/003,965, filed Jan. 3, 2008. U.S. patent application Ser. No. 12/003,965 claims benefit of U.S. Provisional Patent Application No. 60/878,342, filed Jan. 3, 2007, and U.S. Provisional Patent Application No. 60/906,824, filed Mar. 14, 2007. The disclosures of each of these applications are incorporated by reference herein in their entireties.

### BACKGROUND OF THE INVENTION

1. Field of the Invention

The present invention relates to methods of nanopatterning using nanoparticles. The present invention also relates to magnetic nanostructures, including magnetic nanoparticles, produced using the nanopatterning methods, as well as magnetic recording media and magnetic storage devices comprising such nanostructures.

2. Background Art

Nanoparticles, including colloidal nanocrystals and nanoparticles, can be readily produced using various chemical syntheses. The use of surface ligands allows the nanoparticles to be readily deposited on various substrates in regular, controlled particle sizes and spacings. For example, spin-coating, dip-coating, or spray coating on a substrate wafer.

In applications such as magnetic recording media, including hard drives, there is an increased need for magnetic media in the nanoscale size range. However, current methods of sputtering magnetic materials results in particles that have a broad size distribution spectrum.

### BRIEF SUMMARY OF THE INVENTION

What is needed therefore are methods for the production of uniformly-sized magnetic nanostructures, and methods for generating such nanostructures in closely packed arrangements.

The present invention fulfills needs present in the art by providing methods for nanopatterning using masking nanoparticles. These nanopatterning methods can then be used to prepare uniform, regularly-spaced magnetic nanostructures.

In an embodiment, the present invention provides methods for generating one or more nanostructures of a magnetic material. In embodiments, one or more masking nanoparticles are disposed on a magnetic substrate material, wherein the nanoparticles cover at least a portion of the substrate at a site. Uncovered magnetic substrate material is removed, thereby forming magnetic substrate nanostructures at the site of the masking nanoparticles, and the masking nanoparticles are removed.

In exemplary embodiments, the magnetic substrate comprises an alloy that comprises one or more of Fe, Co, Ni, Pt, Cr, B, C, and Al, and mixtures of such alloys. Suitably, the alloy comprises CoCrPt.

Suitably, the masking nanoparticles (e.g., 1-20 nm in diameter) are spin-coated, dip-coated, or spray-coated, on the substrate, for example, Pd, Ni, Ru, Co, Au or SiO₂ nanoparticles, can be coated. The magnetic substrate material is suitably etched, but not the masking nanoparticles. The etching can comprise anisotropic etching, such as reactive ion etching or electron beam etching. In exemplary embodiments, the masking nanoparticles are between about 1-10 nm in diameter, and the nanostructures that are generated are between about 1-10 nm in diameter, and suitably are less than about 5 nm apart.

In further embodiments, the present invention provides additional methods for generating one or more nanostructures of a magnetic material. In such embodiments, one or more nanoscale cavities are first formed in a substrate material. The nanoscale cavities are formed by disposing a negative-resistant layer (e.g., e-beam resist or photo-resist) on the substrate. One or more masking nanoparticles are disposed on the negative-resistant layer, wherein the nanoparticles cover at least a portion of the negative-resistant layer. One or more uncovered portions of the negative-resistant layer are reacted to form one or more etch masks comprising one or more portions of reacted negative-resistant layer and one or more portions of un-reacted negative-resistant layer. The masking nanoparticles are removed, thereby revealing the one or more portions of un-reacted negative-resistant layer. Un-reacted portions of the resistant layer are removed, thereby revealing one or more exposed substrate sections. At least a portion of the one or more exposed substrate sections, thereby forming nanoscale cavities in the substrate.

A magnetic material is then disposed in the nanoscale cavities, and excess magnetic material that is above the plane of the substrate is removed, thereby forming one or more nanostructures in the nanoscale cavities. Exemplary sizes and compositions of masking nanoparticles are provided throughout. Suitably, the magnetic material is disposed in the cavities via chemical vapor deposition, physical vapor deposition or evaporation. Suitably, the magnetic material comprises a magnetic alloy comprising one or more of Fe, Co, Ni, Pt, Cr, B, C, and Al, and mixtures of such alloys, such as a magnetic alloy comprising CoCrPt.

Additional methods for generating one or more nanostructures of a magnetic material are provided by the present invention. For example, in such methods, one or more masking nanoparticles are disposed on a substrate (e.g., silicon), wherein the nanoparticles cover at least a portion of the substrate. Uncovered substrate material is removed, thereby forming substrate pillars at the portion of the substrate covered by the masking nanoparticles, and forming substrate cavities at a portion of the substrate not covered by the masking nanoparticles. The masking nanoparticles are removed, and an insulating layer (e.g., an oxide) is disposed on the pillars and at least partially in the cavities, wherein a pit is maintained at the site of the cavities. A magnetic material is then disposed on the insulating layer, wherein the magnetic material forms nanostructures confined to the pits.

Exemplary sizes, compositions and methods of disposing the masking nanoparticles are provided herein, as are methods of removing substrate material, such as via etching. Suitable magnetic materials, and methods for disposing these materials, are provided throughout.

The present invention also provides magnetic nanostructures prepared by the various processes described throughout. Suitably, the magnetic nanostructures are utilized in a magnetic recording medium. In exemplary embodiments, the present invention provides a plurality of magnetic nanostructures. Suitably, the nanostructures comprise diameters between about 1 nanometer and about 10 nanometers, with size distributions no greater than about 15% of a mean diameter of the nanostructures. Suitably, the center-to-center spacing between adjacent nanostructures is less than about 10 nanometers, with the spacing between adjacent nanostructures controlled to comprise a variance of about 10%.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1A-1C show masking nanoparticles prepared in accordance with one embodiment of the present invention.

FIG. 2 shows a flowchart of a method for generating magnetic nanostructures in accordance with one embodiment of the present invention.

FIGS. 3A-3D show a schematic of a method for generating magnetic nanostructures in accordance with one embodiment of the present invention.

FIG. 4 shows a flowchart of a method for generating nanoscale cavities in accordance with one embodiment of the present invention.

FIGS. 5A-5F show a schematic of a method for generating nanoscale cavities in accordance with one embodiment of the present invention.

FIG. 6 shows a flowchart of a method for generating magnetic nanostructures using nanoscale cavities in accordance with one embodiment of the present invention.

FIGS. 7A-7C show a method for generating magnetic nanostructures using nanoscale cavities in accordance with one embodiment of the present invention.

FIG. 8 shows a flowchart of a method for generating nanostructures of a filler (magnetic) material in accordance with one embodiment of the present invention.

FIGS. 9A-9L show a method of generating nanostructures of a filler (magnetic) material in accordance with one embodiment of the present invention.

FIG. 10A shows a flowchart of a method for generating nanoscale cavities in substrate material in accordance with one embodiment of the present invention.

FIG. 10B shows a flowchart of a method for generating magnetic nanostructures in accordance with one embodiment of the present invention.

FIGS. 11A-F show a method of generating nanoscale cavities and nanostructures in accordance with one embodiment of the present invention.

The present invention will now be described with reference to the accompanying drawings. In the drawings, like reference numbers indicate identical or functionally similar elements.

### DETAILED DESCRIPTION OF THE INVENTION

It should be appreciated that the particular implementations shown and described herein are examples of the invention and are not intended to otherwise limit the scope of the present invention in any way. Indeed, for the sake of brevity, conventional electronics, manufacturing, semiconductor devices, and nanocrystal, nanoparticle, nanowire (NW), nanorod, nanotube, and nanoribbon technologies and other functional aspects of the systems (and components of the individual operating components of the systems) may not be described in detail herein. Further, the techniques are suitable for applications in electrical systems, optical systems, consumer electronics, industrial or military electronics, wireless systems, space applications, or any other application.

As used herein, the term “nanostructure” refers to a structure that has at least one region or characteristic dimension with a dimension of less than about 500 nm, including on the order of less than about 1 nm. As used herein, when referring to any numerical value, “about” means a value of 110% of the stated value (e.g. “about 100 nm” encompasses a range of sizes from 90 nm to 110 nm, inclusive). The term “nanostructure” as used herein encompasses nanoparticles, quantum dots, nanocrystals, nanowires, nanorods, nanoribbons, nanotetrapods and other similar nanostructures known to those skilled in the art. As described throughout, nanostructures (including nanoparticles, nanocrystals, quantum dots, nanowires, etc.) suitably have at least one characteristic dimension less than about 500 nm. Suitably, nanostructures are less than about 500 nm, less than about 300 nm, less than about 200 nm, less than about 100 nm, less than about 50 nm, less than about 20 nm, less than about 15 nm, less than about 10 nm or less than about 5 nm in at least one characteristic dimension (e.g., the dimension across the width or length of the nanostructure).

As used herein, the terms “masking nanoparticle” and “masking nanocrystal” are used interchangeably and refer to nanostructures (e.g., nanocrystals) used to pattern a substrate and subsequently utilized to prepare nanostructures and/or nanoscale cavities.

Typically, the region of characteristic dimension is along the smallest axis of the structure. Masking nanoparticles for use in the present invention are suitably substantially the same size in all dimensions, e.g., substantially spherical, though non-spherical nanoparticles can also be used. Masking nanoparticles can be substantially homogenous in material properties, or in certain embodiments, can be heterogeneous. The optical properties of nanoparticles can be determined by their particle size, chemical or surface composition. The present invention provides the ability to tailor masking nanoparticle size in the range between about 1 nm and about 50 nm (suitably about 1 to 20 nm) allows, although the present invention is applicable to other size ranges of nanoparticles. The term “masking nanoparticles” as used herein also encompasses masking nanocrystals, masking nanowires, masking nanorods, masking nanoribbons, masking nanotetrapods, and other similar nanostructures known to those skilled in the art. As described throughout, nanowires (or similar structures) of the present invention suitably have at least one characteristic dimension less than about 500 nm. Suitably, nanowires of the present invention are less than about 500 nm, less than about 300 nm, less than about 200 nm, less than about 100 nm in diameter, less than about 50 nm in diameter, less than about 20 nm in diameter, or less than abut 10 nm in diameter (i.e. the dimension across the width of the nanowire). Examples of such nanowires include semiconductor nanowires as described in Published International Patent Application Nos. WO 02/17362, WO 02/48701, and WO 01/03208, carbon nanotubes, and other elongated conductive or semiconductive structures of like dimensions.

Masking nanoparticles for use in the present invention can be produced using any method known to those skilled in the art. Suitable methods are disclosed in U.S. patent application Ser. No. 11/034,216, filed Jan. 13, 2005, U.S. patent application Ser. No. 10/796,832, filed Mar. 10, 2004, U.S. patent application Ser. No. 10/656,910, filed Sep. 4, 2003, U.S. Provisional Patent Application No. 60/578,236, filed Jun. 8, 2004, and U.S. patent application Ser. No. 11/506,769, filed Aug. 18, 2006, the disclosures of each of which are incorporated by reference herein in their entireties. The masking nanoparticles for use in the present invention can be produced from any suitable material, including an inorganic material, such as inorganic conductive materials (e.g., metals), semiconductive materials and insulator materials. Suitable semiconductor materials include those disclosed in U.S. patent application Ser. No. 10/796,832 and include any type of semiconductor, including group II-VI, group III-V, group IV-VI and group IV semiconductors. Suitable semiconductor materials include, but are not limited to, Si, Ge, Sn, Se, Te, B, C (including diamond), P, BN, BP, BAs, AlN, AlP, AlAs, AlSb, GaN, GaP, GaAs, GaSb, InN, InP, InAs, InSb, AlN, AlP, AlAs, AlSb, GaN, GaP, GaAs, GaSb, ZnO, ZnS, ZnSe, ZnTe, CdS, CdSe, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Al, Ga, In)₂ (S, Se, Te)₃, Al₂CO, and an appropriate combination of two or more such semiconductors. Suitable metals include, but are not limited to, Group 10 atoms such as Pd, Pt or Ni, as well as other metals, including but not limited to, W, Ru, Ta, Co, Mo, Ir, Re, Rh, Hf, Nb, Au, Ag, Fe, and Al. Suitable insulator materials include, but are not limited to, SiO₂, TiO₂ and Si₃N₄. In further embodiments, the masking nanoparticles for use in the practice of the present invention can be prepared from suitable polymers, for example, polystyrene, poly(methyl methacrylate), as well as other polymers known in the art.

The masking nanoparticles useful in the present invention can also further comprise ligands conjugated, associated, or otherwise attached to their surface as described throughout. Suitable ligands include any group known to those skilled in the art, including those disclosed in (and methods of attachment disclosed in) U.S. patent application Ser. No. 10/656,910, U.S. patent application Ser. No. 11/034,216, and U.S. Provisional Patent Application No. 60/578,236, the disclosures of each of which are hereby incorporated by reference herein for all purposes. Use of such ligands can enhance the ability of the masking nanoparticles to associate and spread on the various material surfaces that are being patterned, such that the material surface is substantially covered by masking nanoparticles in a uniform, ordered manner. In addition, such ligands act to keep the individual masking nanoparticles separate from each other so that they do not aggregate together prior to or during application.

Nanostructures produced by the methods of the present invention can be produced from any suitable material, including an inorganic material, such as inorganic conductive materials (e.g., metals), semiconductive materials and insulator materials. Suitable semiconductor materials include those disclosed in U.S. patent application Ser. No. 10/796,832 and include any type of semiconductor, including group II-VI, group III-V, group IV-VI and group IV semiconductors. Suitable semiconductor materials include, but are not limited to, Si, Ge, Sn, Se, Te, B, C (including diamond), P, BN, BP, BAs, AlN, AlP, AlAs, AlSb, GaN, GaP, GaAs, GaSb, InN, InP, InAs, InSb, AlN, AlP, AlAs, AlSb, GaN, GaP, GaAs, GaSb, ZnO, ZnS, ZnSe, ZnTe, CdS, CdSe, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Al, Ga, In)₂ (S, Se, Te)₃, Al₂CO, and an appropriate combination of two or more such semiconductors. Suitable metals include, but are not limited Pd, Pt, Ni, W, Ru, Ta, Co, Mo, Ir, Re, Rh, Hf, Nb, Au, Ag, Fe, Al, WN₂ and TaN. Suitable insulator materials include, but are not limited to, SiO₂, TiO₂ and Si₃N₄.

In suitable embodiments, nanostructures of the present invention are produced from magnetic materials. As used herein, a “magnetic” material is a material that produces a magnetic field, and therefore attracts nearby materials that are capable of being magnetized (e.g., various metals), and repels other magnets. Examples of magnetic materials for use in the practice of the present invention include, but are not limited to various alloys, mixtures and compositions comprising such alloys and mixtures. For example, the magnetic materials suitably comprise alloys comprising one or more of Fe, Co, Ni, Pt, Cr, B, C, and Al, and mixtures of such alloys. For example, the magnetic material can comprise the alloy CoCrPt.

In exemplary embodiments, the present invention provides methods of nanopatterning a substrate. As used herein, the term “nanopatterning” refers to the disposing of masking nanoparticles onto a substrate to form a “nanoparticle pattern mask” which is then used to generate “nanostructures” and “nanocavities” using the various methods described throughout. Masking nanoparticles can be disposed onto a substrate using any suitable method, and includes, for example, spin-coating, dip-coating, spray-coating, layering, spreading, depositing and other forms of disposing onto the substrate. A “nanoparticle pattern mask,” as used herein, refers to a plurality of masking nanoparticles (e.g., 2, 5, 10, 50, 100, 1000, etc.) that have been disposed onto a substrate so as to form a pattern of masking nanoparticles. The masking nanoparticles therefore cover at least a portion of a substrate onto which they have been disposed. Suitably, the masking nanoparticles are substantially uniform in size and substantially uniformly spaced on the substrate. As used herein, the phrase “substantially uniform in size” means that the diameters (cross-sectional diameter of the nanoparticles taken normal to the surface) of nanoparticles (including masking nanoparticles) have a standard distribution of less than about 30%, suitably less than about 25%, less than about 20%, less than about 15% or less than about 10%. As used herein, the phrase “substantially uniformly spaced” means that the center-to-center spacing between adjacent nanoparticles (including masking nanoparticles) varies by less than about 30%, suitably less than about 25%, less than about 20%, less than about 15%, or less than about 10%. Suitably, the masking nanoparticles are homogenously distributed across the surface of the substrate, though in additional embodiments, the masking nanoparticles can be selectively or specifically disposed in a particular area(s) of the substrate, or the distribution can be random across the surface of the substrate.

As discussed throughout, masking nanoparticles for use in the practice of the present invention can be prepared using any suitable process. In exemplary embodiments, the masking nanoparticles are prepared by processes disclosed in U.S. patent application Ser. No. 11/506,769, filed Aug. 18, 2006, the disclosure of which is incorporated by reference herein in its entirety.

For example, masking nanoparticles of the present invention can be prepared from Group 10 metal nanostructures, for example, Pd, Pt or Ni. As discussed throughout U.S. patent application Ser. No. 11/506,769 (the '769 application), a precursor comprising a Group 10 atom having an oxidation state of +2, and that is bonded to one or more oxygen atoms, is provided. The precursor is reacted in the presence of a surfactant and a non-coordinating solvent to produce the masking nanoparticles. Exemplary precursors include precursors in which the Group 10 atom is bonded to one or more carboxylate or beta diketone moieties (e.g., to an oxygen atom of the carboxylate or ketone moiety). For example, the Group 10 atom can be bonded to one or more acetate, butyrate, oxanilate, or acetylacetonate moieties (e.g., to two such moieties). Exemplary surfactants and non-coordinating solvents are described throughout the '769 application, and include, for example, phosphines, thiols, phosphine oxides (e.g., tri-n-alkyl phosphine oxides), sulfonates, amines (e.g., oleylamine), diols (e.g., propanediol), and carboxylic acids.

In further embodiments, the masking nanoparticles can be produced from ruthenium, using, for example, the methods discussed throughout the '769 application. In suitable methods, a precursor comprising a Ru atom (e.g., ruthenium (III) acetylacetonate, ruthenium chloride, or a ruthenocene) is provided and reacted, typically in the presence of an additive such as an oxidizing agent, a base, or a carboxylate (e.g., an acetate) to produce the nanoparticles. Exemplary additives include, but are not limited to, ammonium nitrate, nitric acid, a peroxide, hydrogen peroxide, ammonium acetate, tetramethylammonium acetate, ammonium hydroxide, and tetramethylammonium hydroxide. In still further embodiments the masking nanoparticles can be prepared from SiO₂, or other suitable oxides, such as TiO₂.

As discussed throughout, suitably the masking nanoparticles have a standard deviation in diameter which is less than about 30% of an average diameter of the nanostructures. The standard deviation is suitably less than about 20% of the average diameter, less than about 15%, or less than 10% of the average diameter. The size distribution of the masking nanoparticles is preferably monomodal. The masking nanoparticles can be of essentially any size, but the average diameter is suitably less than about 20 nm, for example, between about 1-20 nm, or between about 1-15 nm, between about 1-10 nm, between about 3-10 nm, or between about 1-5 nm. For example, the masking nanoparticles can be about 20 nm in diameter, or about 19 nm, about 18 nm, about 17 nm, about 16 nm, about 15 nm, about 14 nm, about 13 nm, about 12 nm, about 11 nm, about 10 nm, about 9 nm, about 8 nm, about 7 nm, about 6 nm, about 5 nm, about 4 nm, about 3 nm, about 2 nm, or about 1 rm. The masking nanoparticles can be of essentially any shape, including spherical (or substantially spherical, e.g., oblong), rods, wires tetrapods or other shapes.

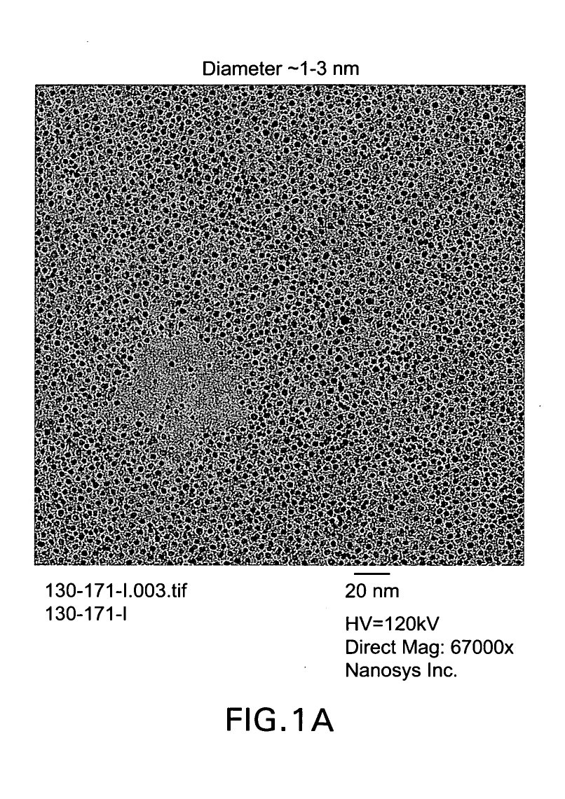

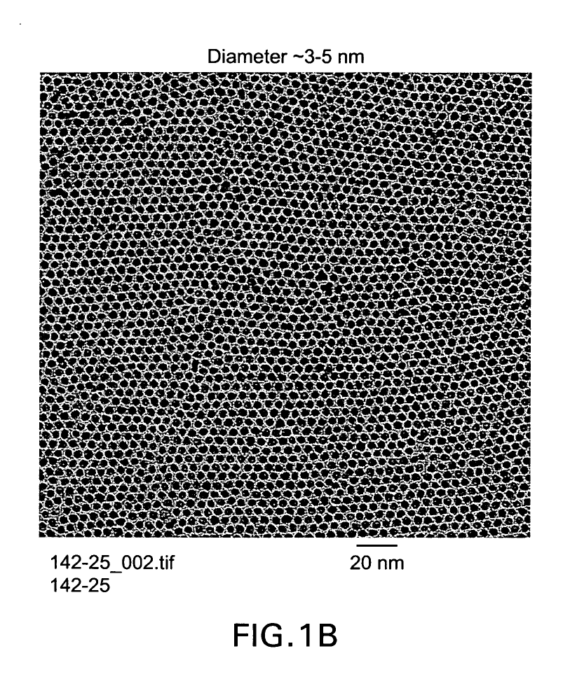

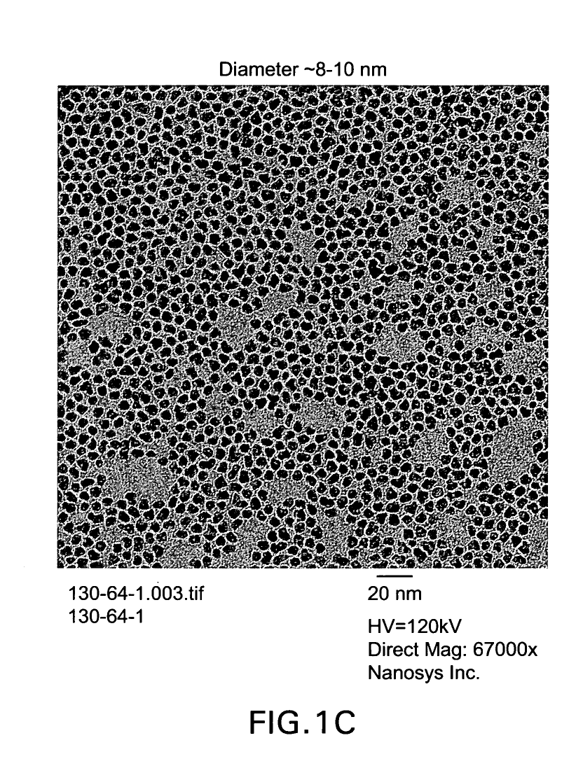

Through variations in incubation temperature, time and other factors, the size of the masking nanoparticles can be tightly controlled. For example, as shown in FIGS. 1A-1C, masking nanoparticles with diameters of about 1 nm to about 10 nm can be reproducibly prepared, with very little variability in their diameters. FIG. 1A shows a transmission electron micrograph (TEM) of ruthenium masking nanoparticles prepared in accordance with the methods described herein and in the '769 application. The diameter of the nanoparticles ranges from about 1 nm to about 3 nm, and as can be seen, the variability between the size of the particles is quite small. In preparation for the TEM, the nanoparticles were spin coated onto the substrate, resulting in a very evenly distributed coating of nanoparticles. As can be seen in FIG. 1A, the center-to-center distance between the nanoparticles is very uniform, generally on the order of about 3-5 nm.

FIG. 1B shows a TEM of masking nanoparticles of about 3-5 nm in diameter prepared in accordance with the present invention. FIG. 1B demonstrates the extremely small variation in nanoparticle diameter, as well as center-to-center spacing between adjacent nanoparticles. FIG. 1C shows an additional TEM of masking nanoparticles having a diameter of between about 8-10 nm. As in FIGS. 1A and 1B, the diameter of the nanoparticles is very uniform, as is the inter-nanoparticle spacing. The pattern of masking nanoparticles exhibits some additional heterogeneity, but overall the spin-coating method has produced a uniform pattern.

### Nanostructures and Nanocavities

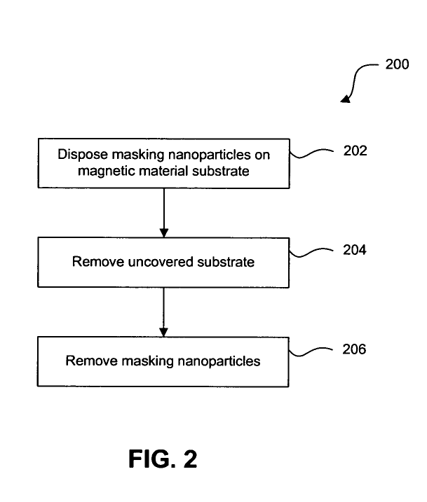

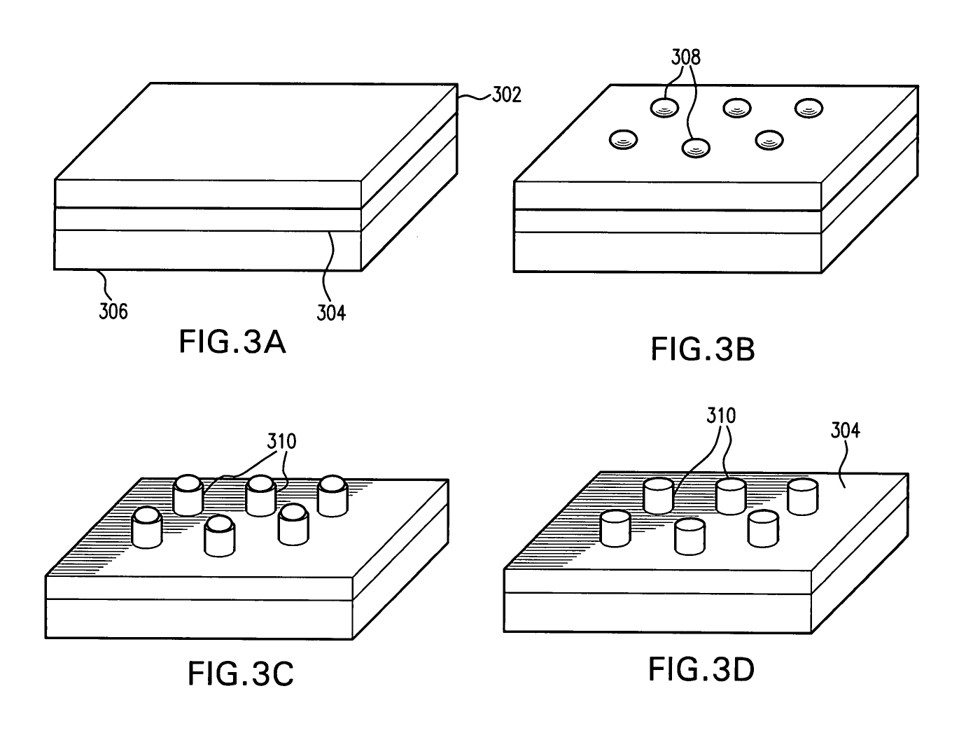

In one embodiment, as shown in flowchart 200 of FIG. 2, with reference to the schematic in FIGS. 3A-3D, the present invention provides methods for generating one or more nanostructures, as well as nanostructures prepared by such methods. In suitable embodiments, the methods are useful for preparing nanostructures of magnetic materials. In step 202 of FIG. 2 one or more masking nanoparticles 308 are disposed on a substrate 302, to at least cover a portion of the substrate (see FIG. 3B). Suitably, substrate material 302 is a magnetic material. Substrate 302 can be provided by itself, or it can be provided layered or otherwise associated with additional optional substrates. For example, as shown in FIG. 3A, substrate material 302 can be layered on optional support layer 304 which is itself layered on optional base substrate 306.

Any suitable substrate material can be utilized in the practice of the present invention, and hence, nanostructures of any suitable substrate can be produced using the methods described throughout. In exemplary embodiments, substrate 302 is a magnetic material, for example, an alloy comprising Fe, Co, Ni, Pt, Pd, Cr, B, C, Cu, and/or Al, and mixtures of such alloys. For example, the magnetic material can comprise the alloy CoCrPt.

In exemplary embodiments, substrate material 302 comprises a contiguous layer of magnetic material that has been formed on an optional supporting substrate layer, for example, a supporting substrate layer (304), which is suitably a glass supporting substrate layer, such as SiO₂. Any method can be used to form substrate layer 302, for example, sputtering, CVD/PVD, or other deposition method can be used to deposit a layer of magnetic material on, for example, a glass supporting substrate layer (304) that can be further supported by a further optional base substrate (306). The thickness of layers 302, 304 and 306 vary depending upon the type of substrate and optional substrate layers. Suitably, substrate material 302 (e.g., magnetic material) is on the order of 1-50 nm thick, more suitably about 1-20 nm or about 1-10 nm, most suitably about 1-8 nm, e.g., about 2 nm, about 3 nm, about 4 nm, about 5 nm, about 6 nm, about 7 nm or about 8 nm thick. Optional supporting substrate layer 304 (e.g., a glass layer) is suitably on the order of 10s-100s of nanometers, to millimeters, to centimeters, in thickness, though thinner or thicker layers can also be utilized. Optional base substrate 306 is suitably on the order of 100s of nanometers thick, to several millimeters or larger, depending on the desired substrate and application.

As used herein and discussed throughout, methods for disposing masking nanoparticles 308 on substrate 302 include any suitable method known in the art, such as spin-coating, dip-coating and spray-coating. The term “disposing” as used herein is meant to encompass any of the terms known in the art such as formed, layered, attached, associated, generated, deposited, grown, bonded, etc., which indicate that the masking nanoparticles of the present invention are associated with a surface of the substrate 302. Methods for spin-coating nanoparticles onto substrates are known, for example, as disclosed in, U.S. patent application Ser. No. 10/674,060, filed Sep. 30, 2003, the disclosure of which is incorporated by reference herein in its entirety. Methods of dip-coating nanoparticles on substrates are well known in the art, for example, as disclosed in Gao et al., IEEE Transactions on Magnetics, 31:2982-2984 (1995), the disclosure of which is incorporated by reference herein in its entirety. As discussed throughout, masking nanoparticles can be prepared from any suitable material, including metals, semiconductors and polymers. Suitably, the masking nanoparticles are prepared from metals including, but not limited to, Pd, Ni, Ru, Co and Au, or the masking nanoparticles can be prepared from oxides, such as SiO₂ or TiO₂. In exemplary embodiments, the diameter of the masking nanoparticles is between about 1 nm to about 20 nm, suitably about 1 nm to about 15 nm, about 1 nm to about 10 nm, or about 3 nm to about 10 nm, e.g., about 1 nm, about 2 nm, about 3 nm, about 4 nm, about 5 nm, about 6 nm, about 7 nm, about 8 nm, about 9 nm or about 10 nm in diameter. As demonstrated in FIGS. 1A-1C, the diameter of the masking nanoparticles of the present invention can be controlled such that the masking nanoparticles are “substantially uniform in size,” i.e., such that the diameters vary by less than about 15%. Furthermore, as shown in FIGS. 1A-1C, masking nanoparticles 308 are disposed on substrate 302 in a uniform orientation or pattern, such that a substantial portion of substrate 302 is covered by masking nanoparticles, e.g., greater than about 50%, greater than about 60%, greater than about 70%, greater than about 80%, greater than about 90%, or greater than about 95% of substrate 302 is covered.

Masking nanoparticles provide a way to selectively cover portions of substrate 302, such that these covered portions are protected from external reactants (chemicals, light, electron-beam (e-beam), plasma, heat, other energy/reaction sources). However, uncovered portions remain exposed to reactants in the surrounding environment. For example, as shown in step 204 of flowchart 200, when uncovered substrate is selectively removed from substrate 302, substrate nanostructures 310 remain at the site of the masking nanoparticles. Suitably, uncovered substrate is removed by etching substrate 302. However, since the portions of substrate 302 that are covered by masking nanoparticles 308 are protected from etching, only the unprotected portions of substrate 302 are removed. Therefore, as substrate 302 is selectively etched, nanostructures 310 are formed “below” the masking nanoparticles (e.g., FIG. 3C). It should be understood that the term “below” represents one embodiment of the present invention in which the spatial orientation of substrate 302 and masking nanoparticles 308 is as represented in FIGS. 3A-3D, and other spatial orientations are readily envisioned by one of ordinary skill in the art and therefore fall within the scope of the present invention. It should also be understood that the number and orientation/spacing of masking nanoparticles 308 in FIGS. 3A-3D is provided only for illustrative purposes. In exemplary embodiments, masking nanoparticles 308 are disposed in closer proximity and over a wider range on substrate 302 than is illustrate in FIGS. 3A-3D.

As used herein, the terms “etch” or “etching” refer to any process, including chemical, physical, or energetic, which removes exposed or uncovered material of a substrate. Examples of suitable etching methods include, but are not limited to, chemical etching, such as acid or base etching, including wet chemical etches (e.g., using Acetic Acid (H₃COOH), Hydrochloric Acid (HCl), Hydrofluoric Acid (HF), Nitric Acid (HNO₃), Phosphoric Acid (H₃PO₄), Potassium Hydroxide (KOH), Sodium Hydroxide (NaOH), Sulfuric Acid (H₂SO₄), as well as other chemicals known by one of ordinary skill in the art, see e.g., U.S. Pat. Nos. 7,153,782, 7,115,526, 5,820,689); photochemical etching, see e.g., U.S. Pat. Nos. 4,414,066 and 5,092,957, as well as Ashby, “Photochemical Dry Etching of GaAs”, Appl. Phys. Lett. 45:892 (1984); Ashby et al., “Composition-selective Photochemical Etching of Compound Semiconductors”, Appl. Phys. Lett. 47:62 (1985), Smith, R. A., Semiconductors, 2nd Ed., Cambridge Univ. Press, New York, 1978, p. 279; plasma etching, see e.g., U.S. Pat. Nos. 3,615,956, 4,057,460, 4,464,223 and 4,595,454; reactive ion etching (RIE) see e.g., U.S. Pat. Nos. 3,994,793, 4,523,976 and 4,599,136; electron beam (e-beam) etching, see e.g., U.S. Pat. Nos. 4,639,301, 5,149,974 and 6,753,538, and also, Matsui et al., “Electron Beam Induced Selective Etching and Deposition Technology,” Journal of Vacuum Science and Technology B 7 (1989), Winkler et al. “E-Beam Probe Station With Integrated Tool For Electron Beam Induced Etching,” Microelectronic Engineering 31:141-147 (1996). Each of the patents and references listed above are hereby incorporated by reference herein in their entireties for all purposes, specifically for their disclosure of various etching methods and compositions. As represented in FIGS. 3A-D, substrate 302 is preferentially/selectively removed (e.g., preferentially/selectively etched), such that substrate material 302 is removed, but masking nanoparticles 308 are not removed/etched. Preferential removal/etching in accordance with the present invention requires selection of enchants that etch substrate 302, but not masking nanoparticles 308 (it should be understood that some etching of substrate is acceptable in the practice of the present invention). In embodiments where both substrate 302 and masking nanoparticles 308 comprise metal, careful selection of etchant(s) is required so that only substrate 302 is substantially etched. Such selectivity is readily determined by those of ordinary skill in the art, as described throughout the references noted above.

In exemplary embodiments, uncovered portions of substrate 302 are removed by etching anisotropically. As used herein, etching anisotropically means that the rate of etching in one primary direction is greater than the rate of etching in other directions. Suitably, in anisotropic etching, the rate of etching is nearly zero in directions other than the primary direction (for example, normal to the plane of the substrate surface). In further embodiments, the etching of substrate 302 can occur isotropically. Isotropic etching refers to an etching process in which the rate of etching is the same, or substantially the same, in all directions. That is, there is no primary direction of etching. For use in the practice of the present invention, while either anisotropic or isotropic etching can be used, anisotropic etching provides a method for controlling the amount, orientation and type of substrate that is being etched.

For example, as shown in FIG. 3C, the use of an anisotropic etch (e.g., RIE or electron beam etching) allows for substrate 302 that is not covered by masking nanoparticles to be etched away, but only in a direction that is normal to the plane of the substrate, thereby forming nanostructures below the masking nanoparticles 308. As the substrate is etched away anisotropically, i.e., only in a direction normal to the plane of the substrate, the cross-sectional diameter of the nanostructures that are generated are substantially the same size as the masking nanoparticles that covered the substrate. For example, if masking nanoparticles with a diameter of about 4 nm are disposed on a substrate and an anisotropic etch is performed on uncovered portions of the substrate such that the etching proceeds to a depth of about 4 nm, nanostructures with dimensions on the order of about 4×4 nm are generated. In further embodiments, the anisotropic etch can be performed for a longer or shorter time, so that nanostructures are formed that have one dimension longer than the other. For example, nanostructures with a cross-sectional diameter equal to about the diameter of the masking nanoparticles, but an extended length dimension can be generated. Or, disk-like nanostructures can be generated in which the cross-sectional diameter dictated by the size of the nanostructures is the larger dimension, and the “height” of the discs, the shorter dimension.

In further embodiments, the removing that takes place in step 204 of FIG. 2 can comprise an isotropic etch, such that substrate 302 that is both uncovered, and covered by masking nanoparticles 308 is etched at substantially the same rate. Nanostructures produced according to this embodiment have an initial cross-sectional diameter dictated by the size of the masking nanoparticles. However, as the isotropic etch removes substrate 302 both normal to the plane of the substrate, and substrate that is beneath the masking nanoparticles, the diameter of the nanostructure narrows as you move into the substrate. For example, a conical or hemispherical shape can be generated. As noted above, the size of the nanostructures generated using the methods of the present invention is controlled not only by the cross-sectional diameter of the masking nanoparticle, but also the depth that the etch removes material into the plane of the substrate.

As shown in step 206 of FIG. 2, masking nanoparticles 308 are then removed from substrate 302 and generated nanostructures 310, leaving nanostructures 310, as in FIG. 3D. Any suitable method can be used to remove masking nanoparticles, for example, simply washing or rinsing substrate 302 with a solution (e.g., alcohol or aqueous solution) to remove the masking nanoparticles. In other embodiments, the masking nanoparticles can be selectively etched away using the various methods known in the art and discussed throughout, or they can be melted away, or simply physically removed.

As shown in FIG. 3D, if an optional insulating layer 304 is disposed beneath substrate 302, the methods of the present invention allow for generation of nanostructures using various etching methods such that nanostructures 310 are positioned directly on the insulating layer 304, and hence, separated from one another by an insulating material 304. In suitable embodiments, the thickness of substrate 302 is such that removing (e.g., etching) in step 204 of FIG. 2 removes all uncovered substrate, and may even remove some portion of an underlying optional insulating layer 304. This allows for the generation of separated, individual nanostructures 310 that are not electrically connected.

In exemplary embodiments, the nanostructures of the present invention prepared from magnetic substrate material are suitably used in magnetic recording media, such as magnetic recording tape and hard disk drives (e.g., nanostructures of magnetic recording media or magnetic storage). As used herein “magnetic recording media” and “magnetic storage” refer to magnetizable materials which can accommodate different patterns of magnetization in the materials, thereby allowing the storage of data (e.g., a series of 0s and 1s).

Hard disk drives (HDDs), which are auxiliary memory devices for computers, reproduce information stored in a magnetic disk or record new information on the magnetic disk by way of a magnetic head. The device reads and/or writes data from and/or to a disk using a magnetic head. The disk is often rotatably mounted on a spindle motor, and information is accessed by the magnetic head, namely, read/write head, mounted on an actuator arm that is rotated by a voice coil motor. The voice coil motor is excited by a current to rotate an actuator and move the read/write head. The read/write head detects a magnetic change occurring on a surface of the disk and reads the information recorded on the surface of the disk. To write information on a data track, current is supplied to the read/write head. The current creates a magnetic field, thereby magnetizing the surface of the disk.

The present invention provides control of the size and size distribution of the magnetic nanoparticles, thereby generating uniform particles for use in magnetic recording media of, for example, hard disk drives. The improved size distribution allows smaller average particle/grain sizes that leads to more magnetic particles/grains in each stored bit. The signal-to-noise ratio of the stored information is highly dependent on the number of particles/grains per bit. Therefore, higher signal-to-noise ratio can be achieved for the same generation magnetic media by using smaller particles with tighter size distribution. Furthermore, the smaller particle/grain size combined with tighter size distribution enables even higher magnetic storage density by reducing the bit size while keeping the number of particles/grains roughly the same.

In addition, the methods of the present invention also allow for the uniform particles to be spaced very closely together in a uniform matter. For example, in suitable embodiments, the spacing between adjacent particles (i.e., nearest neighbor particles) is suitably on the order of less than about 10 nm, suitably less than 9 nm, less than about 8 nm, less than about 7 nm, less than about 6 nm, less than about 5 nm, less than about 4 nm, less than about 3 nm, less than about 2 nm, less than about 1 nm, or for example, on the order of a few to 10s of angstroms (Å).

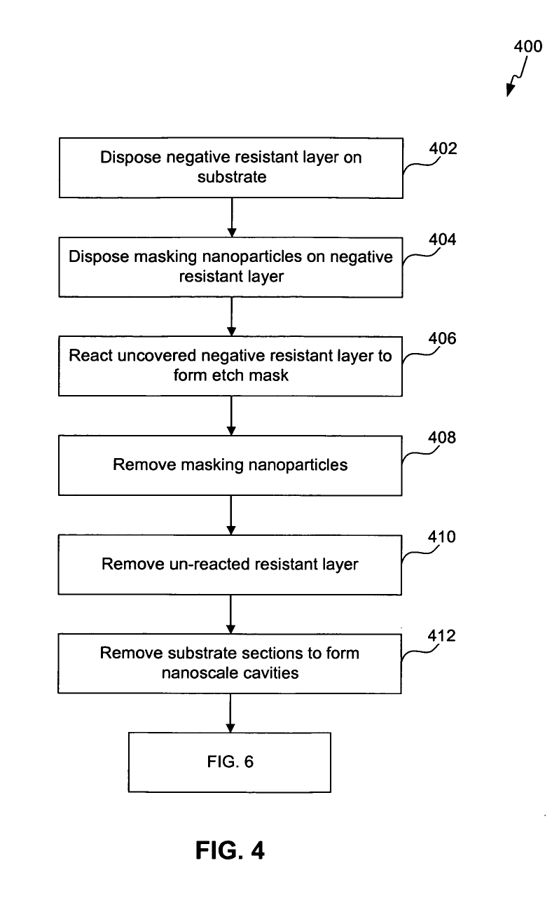

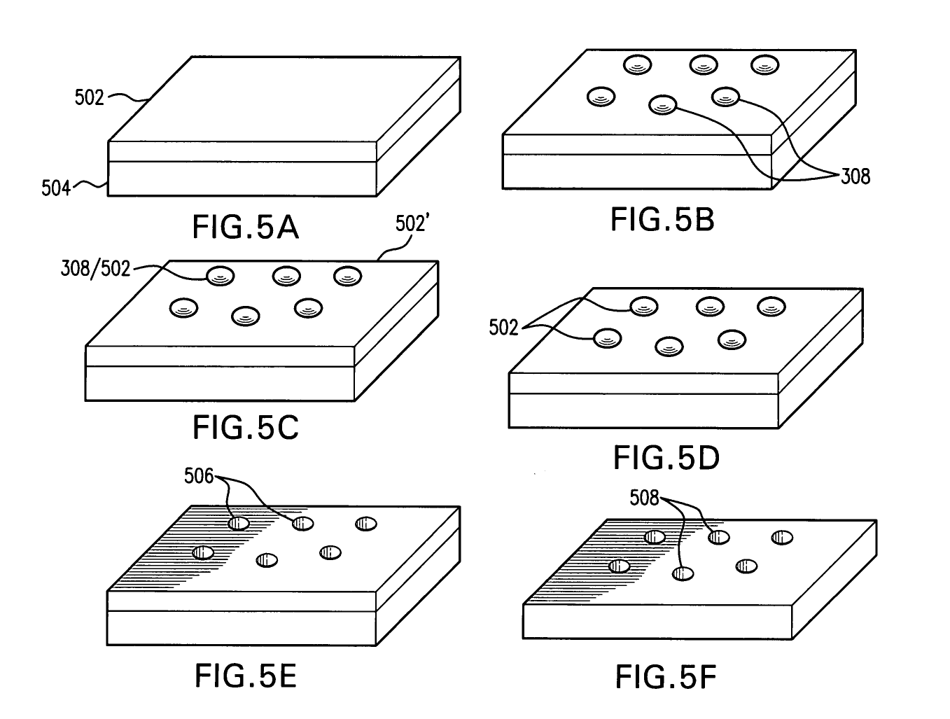

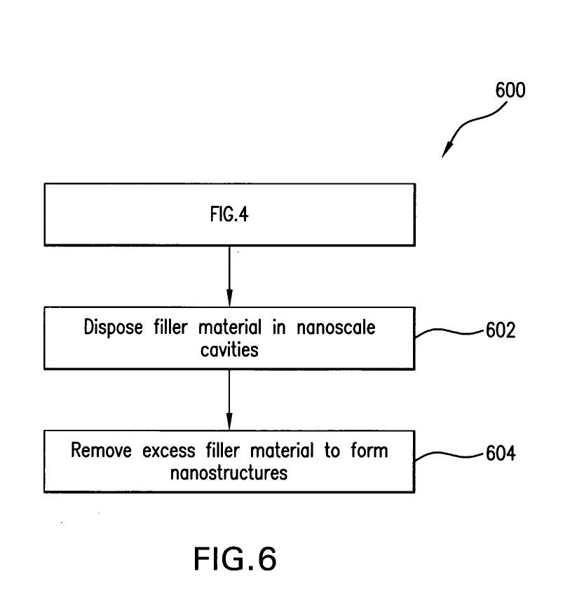

In additional embodiments, the present invention provides methods of generating nanoscale cavities in substrate materials, as shown in flowchart 400 of FIG. 4, with reference to FIGS. 5A-5F, as well as nanoscale cavities produced by such methods. As shown in FIG. 4, in step 402, a negative resistant layer 502 (e.g., negative photoresist or negative e-beam resist) is disposed on a surface of substrate 504 (FIG. 5A). Any suitable material can be used as substrate 504, though in exemplary embodiments, substrate 504 is an electrically insulating substrate, for example an oxide such as SiO₂. As used herein, a “negative resistant layer” refers to a material that, when exposed to energy or radiation (including visible and ultraviolet light wavelengths, as well as electron beam (e-beam) or x-ray radiation) becomes relatively insoluble to a resist developer. Unexposed portions (i.e., covered) of the negative resistant layer are then able to be dissolved by a resist developer, while covered regions are not able to be developed. Examples of methods of the use of a negative resist layers, including negative photoresist and negative e-beam resist layers, as well as developers, including photoresist and e-beam resist developers, can be found in, for example, Sze, S. M., “Semiconductor Devices, Physics and Technology,” John Wiley & Sons, New York, pp. 436-442 (1985), and in U.S. Pat. No. 7,425,392, the disclosures of each of which are incorporated by reference herein in their entireties. In general, negative resists for use in the practice of the present invention comprise a polymer combined with a photosensitive compound or e-beam sensitive compound. Upon exposure to radiation (e.g., UV light or e-beam), the photosensitive or e-beam sensitive compound cross-links the polymer, rendering it resistant to a developing solvent. Unexposed areas, however, are removable by the developing solvent. Some exemplary negative photoresist materials and developers include Kodak® 747, copolymer-ethyl acrylate and glycidylmethacrylate (COP), GeSe and poly(glycidyl methacrylate-co-ethyl acrylate) DCOPA. Negative e-beam resists include various polymers that are known in the art, including for example, poly(methylmethacrylate) (PMMA), hydrogen silsesquioxane (e.g., XR-1541 from Dow Corning, Delaware), etc. Disposing of negative photoresist layers 502 can be performed using any suitable method, for example, spin-coating, dip-coating, spray-coating, or otherwise layering the layer.

In step 404 of flowchart 400 of FIG. 4, one or more masking nanoparticles 308 are then disposed on a surface of the negative resist layer 502 opposite the substrate 504 to cover at least a portion of the negative resist layer 502, as shown in FIG. 5B. Masking nanoparticles 308 can be disposed onto the negative resist layer 502 using any suitable method, for example, spin-coating, spray-coating, dip-coating, or otherwise layering the nanoparticles. Exemplary materials, sizes and shapes of masking nanoparticles 308 are discussed throughout. It should also be understood that the number and orientation/spacing of masking nanoparticles 308 as shown in FIG. 5B is provided only for illustrative purposes. In exemplary embodiments, masking nanoparticles 308 are disposed in closer proximity and over a wider range on negative resist layer 502 than is illustrated in FIGS. 5A-5F.

In step 406 of FIG. 4, uncovered portions of negative resist layer 502 are reacted to form an etch mask. As noted above, various forms of radiation can be used to react the negative resist, including ultraviolet light and e-beam radiation. Reacting negative-resist 502 converts the resist to a material that is resistant to removal by a developer, thereby forming an etch mask comprising one or more portions of a reacted negative resist 502′ and one or more portions of unreacted negative resist covered by masking nanoparticles 308/502, as shown in FIG. 5C. Removal of masking nanoparticles 308 in step 408 of FIG. 4 reveals the one or more portions of unreacted negative resist 502 that were originally covered by masking nanoparticles 308, as shown in FIG. 5D. Any suitable method can be used to remove masking nanoparticles 308, for example, simply rinsing substrate 502/502′ with a solution, e.g., an alcohol or aqueous-based solution.

In step 410 of flowchart 400 of FIG. 4, unreacted portions of negative resist 502 are removed, suitably by reacting the portions with a developing solvent. As shown in FIG. 5E, removal of these portions reveals one or more exposed substrate sections 506 of substrate 504. Substrate 504 still covered by reacted negative resist 502′ is protected from any subsequent removal process (e.g., etching). Thus, the methods of the present invention provide a means for producing a negative resist layer that has nanopatterned openings or portions throughout.

In step 412 of FIG. 4, exposed substrate sections 506 are then removed. For example, substrate sections 506 are removed normal to the surface of the substrate, thereby forming one or more nanoscale cavities 508 at the site of the exposed sections, as shown in FIG. 5F. Suitably, substrate sections are removed by etching, including anisotropically etching via RIE or electron beam etching, as described throughout. While the methods of the present invention directed to forming nanoscale cavities can be performed on any suitable substrate, in exemplary embodiments, the nanoscale cavities are formed in an substrate such as SiO₂.

The cross-sectional diameter of nanoscale cavities 508 is dictated by the diameter of masking nanoparticles 308, and hence, as discussed throughout, nanoscale cavities on the order of between about 1-20 nm in diameter, suitably about 1-10 nm in diameter, or about 1-5 nm in diameter are readily prepared. The depth of nanoscale cavities 508 is controlled by the extent of removal of substrate 504 in step 412. Thus, by controlling the time of removal (etch), and the removal (etch) rate (e.g., via varying the type of etch and intensity), the depth of nanoscale cavities can be controlled to any desired depth. Suitably, the depth of removal (etch) is similar to the diameter of the masking nanoparticles/nanoscale cavities, i.e., between about 1-20 nm, though deeper cavities can be prepared depending on the desired final application. In addition, as described herein, the spacing between adjacent nanoscale cavities can be controlled such that nearest neighbor cavities can be separated by less than about 10 nm, less than about 5 nm, or less than about 1 nm, for example, on the order of a few or tens of Å.

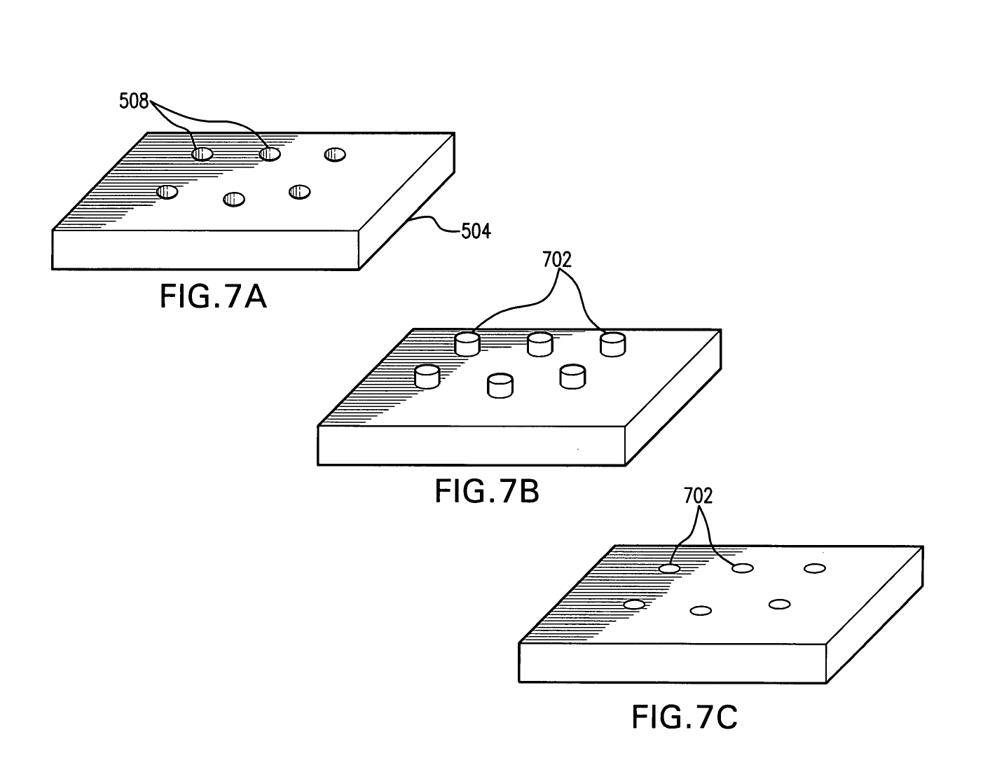

Substrates comprising nanoscale cavities prepared in accordance with the present invention can be used to create nanostructures, as shown in flowchart 600 of FIG. 6, with reference to FIGS. 7A-7C. For example, as shown in flowchart 600 of FIG. 6, upon providing a substrate material 504 with nanoscale cavities 508 (e.g., the product of FIG. 4, FIG. 7A), a filler material 702 can then be disposed in the nanoscale cavities 508 in step 602 of FIG. 6, as shown in FIG. 7B. Any suitable method for disposing filler material 702 into nanoscale cavities can be used, for example, chemical vapor deposition, physical vapor deposition, evaporation, etc.

In general, filler material 702 is a magnetic material, such as those described throughout. The ability to prepare nanoscale cavities 508 that have a defined size (dictated by the diameter of masking nanoparticles 308 and the depth of removal/etch), allows for the preparation of nanostructures by simply filling the cavities with a filler material (e.g., a magnetic material). As shown in step 604 of FIG. 6, excess filler material 702 can then optionally be removed, thereby resulting in nanostructures that are of a defined size. For example, by etching filler material 702, excess material is removed down to the level (or below) of the surface of substrate 504. Suitable etching methods, including RIE and electron beam etching are described throughout. Removal in step 604 can comprise anisotropic or isotropic etching, thereby removing filler material in all orientations, or in a preferred orientation, e.g., into the plane of substrate 504. In additional embodiments, heating can be used to locate filler material 702 to the sites of the nanoscale cavities 508. For example, filler material 702 can be heated to a temperature above its melting temperature such that it flows into nanoscale cavities, and thus is removed, or substantially removed, from the surface of substrate 504.

Filler material 702 thereby forms nanostructures throughout substrate 504, each separated from another by substrate 504. In suitable embodiments, filler material comprises a magnetic material, and nanostructures of these magnetic materials can be separated by substrate 504, which can be an insulator such as SiO₂. In embodiments in which nanocavities are generated in SiO₂, and then a magnetic filler material is used to generate nanostructures in the dielectric, such embodiments allow for the production of layers comprising very high nanostructure density with fairly thin sections of SiO₂ between nanostructures.

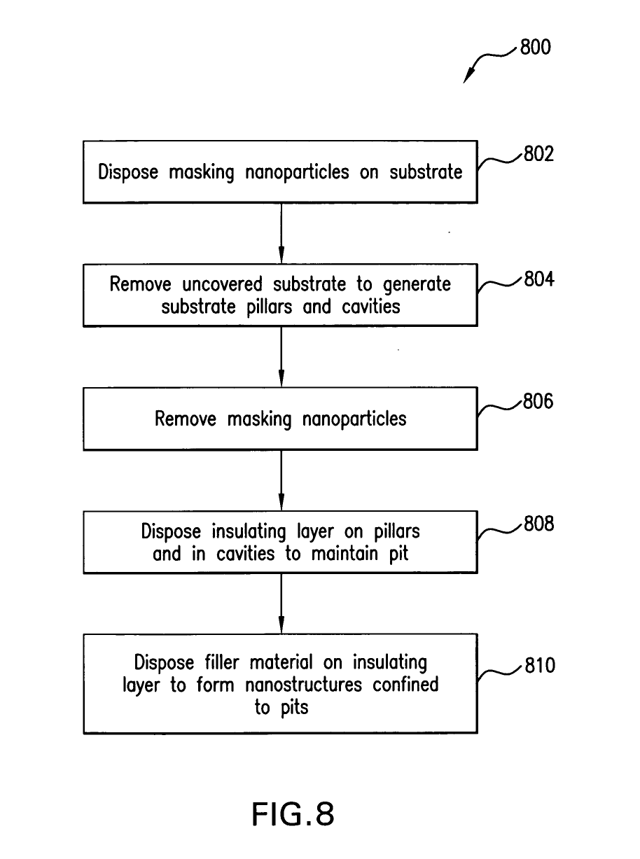

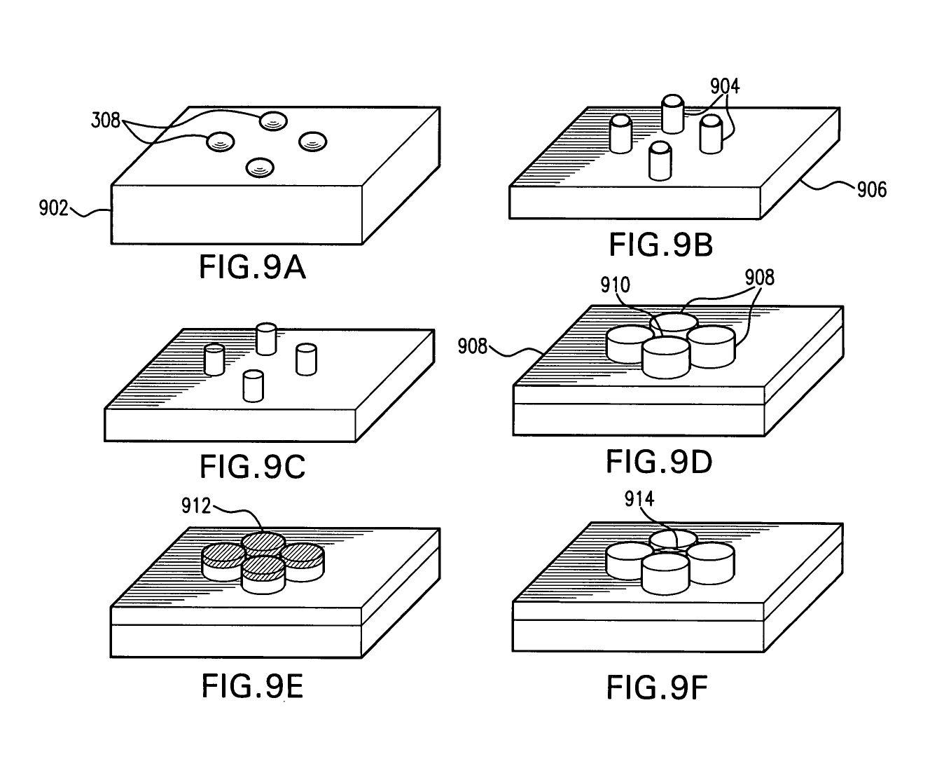

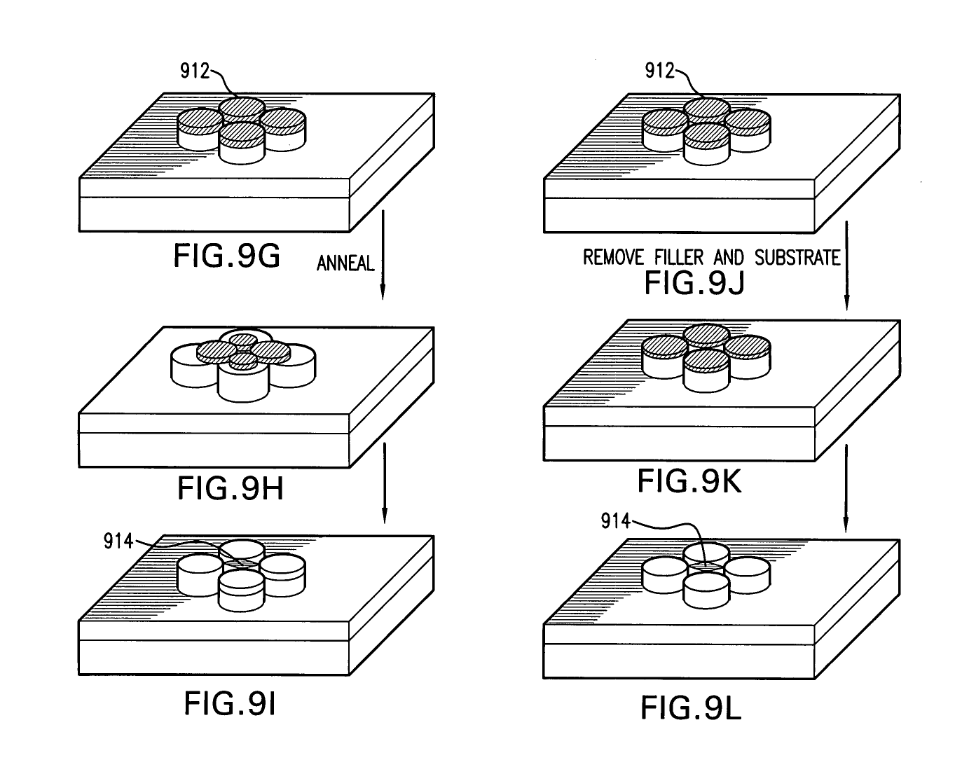

Further methods are provided for generating one or more nanostructures of a filler material (e.g., a magnetic material), as shown in flowchart 800 in FIG. 8 with reference to FIGS. 9A-9L, as well as nanostructures of magnetic materials prepared by such methods. In step 802 of FIG. 8, one or more masking nanoparticles 308 are disposed on a surface of substrate 902 to a least cover a portion of the substrate. Suitably, substrate 902 is a semiconductor material, for example, Si, Ge, Sn, Se, Te, B or C. Exemplary materials, sizes and shapes of masking nanoparticles 308 are described throughout, as are methods for disposing masking nanoparticles on a surface of substrate 902. Suitably masking nanoparticles 308 are between about 1-10 nm, or about 3-10 nm, or suitably about 1-5 nm in diameter, and comprise a metal such as Pd, Ni, Ru, Co or Au, or SiO₂. The ability to provide a uniform disposition of masking nanoparticles 308 on substrate 902, allows for a very tightly controlled center-to-center spacing. For example, as shown in FIGS. 1A-1C, the center-to-center spacing can be controlled to within about 15%, with a separation distance of about 1-10 nm, suitably about 3-8 nm. It should also be understood that the number and orientation/spacing of masking nanoparticles 308 in FIGS. 9A-9L is provided only for illustrative purposes. In exemplary embodiments, masking nanoparticles 308 are disposed in closer proximity and over a wider area on substrate 902 than is illustrated in FIGS. 9A-9L.

In step 804 of FIG. 8, uncovered substrate material 902 is removed, suitably normal to the substrate surface, thereby forming substrate pillars 904 at the portion of the substrate covered by masking nanoparticles 308. As shown in FIG. 9B, substrate cavities 906 are also formed between substrate pillars 904 at portions of substrate 902 that were not covered by masking nanoparticles 308. Step 804 is similar to step 204 of FIG. 2, in which nanostructures of a substrate were generated by selectively removing material that was not covered by masking nanoparticles 308. Step 804 also results in the generation of nanostructures with a cross-sectional diameter that is about the same as the diameter of masking nanoparticles 308. While the “depth” or “height” of substrate pillars 904 may be larger than the nanostructures prepared in step 206, the process of preparation is very similar. As noted above, exemplary methods for selectively removing substrate material that can be used in step 804 include various etching methods, including RIE and electron beam etching. Suitably the etching is anisotropic etching so as to form substrate pillars 904 that have substantially uniform diameters throughout their length. In step 806 of FIG. 8, masking nanoparticles 308 are removed as shown in FIG. 9C, for example, by rinsing the substrate with a solution, e.g., an alcohol or aqueous-based solution.

In step 808 of FIG. 8, an insulating layer 908 is then disposed on the pillars 904 and cavities 906, so that a pit 910 is maintained at the site of the cavities, as shown in FIG. 9D. Suitably, insulating layer 908 is disposed on substrate 902 by growing an oxide layer. For example, if substrate 902 comprises Si, and oxygen is provided to the substrate, a layer of SiO₂ grows on the substrate pillars 904 and cavities 906. As insulating layer 908 is disposed, e.g., grown, on substrate pillars 904 and cavities 906, the layer “grows” equally in all directions from/on the substrate. That is, the layer increases in thickness in a direction normal to the substrate surface 902 on both the cavities 906 and pillars 904, as well as in directions that are parallel to the substrate surface 902, e.g., in directions normal (or substantially normal) to the sides of pillars 904. As used throughout, the term “grows,” as used to describe the disposition of insulating layer 908 is used to indicate that the insulating layer is formed, applied, deposited or otherwise generated on substrate 902, substrate pillars 904 and cavities 906, and is not to be limited to actual growth of the insulating layer (e.g., an oxide layer). For example, as shown in FIG. 9D, insulating layer 908 grows in all directions from substrate 902, including normal to the surface of substrate 902 and substrate cavities 906, as well as from the top and sides of substrate pillars 904.

The amount of insulating layer 908 that is disposed on the substrate surfaces can be controlled in various ways, depending on the method of disposition. For example, by removing or increasing the amount of oxygen, the thickness of a growing oxide layer can be controlled. By controlling the amount of insulating layer disposed on the various substrate surfaces, a pit 910 is maintained at the site of cavities 906. As insulating layer 908 is disposed equally on all surfaces of substrate 902, pit 910 is therefore lined (i.e., bottom and sides of the pit) with the insulating material, as shown in FIG. 9D. Pits 910 can be formed in any shape, but suitably they are in a hemisphere or conical shape. In suitable embodiments, as insulating layer 908 is disposed on substrate 902, the layer increases in thickness from the sides of substrate pillars 904 as well as from the cavities 906 in such a way that an inverted cone or pyramid shape is generated. In addition to controlling the shape of pits 910, the size of pit 910 is very tightly controlled by providing a uniform disposition of masking nanoparticles 308 as discussed above. For example, as shown in FIGS. 1A-1C, center-center spacings, and hence, the size of cavities 906, can be controlled to within about 15%, with a separation of about 1-20 nm, suitably about 1-10 nm. Thus, pits 910 formed at the site of cavities 906 can also be controlled in this range, thereby forming pits with sizes of less than about 20 nm, suitably less than about 10 nm (about 10 nm to about 3 nm), or less than about 5 nm.

In step 810 of FIG. 8, a filler material 912 (e.g., a magnetic material) is disposed on the insulating layer 908, wherein the filler material is confined to pits 910. As shown in FIGS. 9E and 9F, in suitable embodiments, filler material 912 is disposed on insulating layer that forms the surface of pits 910, as well as insulating layer 908 that is outside of pits 910. As discussed throughout, filler material suitably comprises a magnetic material as described throughout. Exemplary methods for disposing filler material 912 are also discussed throughout, and include, for example, chemical vapor deposition, physical vapor deposition and evaporation.

While in exemplary embodiments, filler material is disposed only at the sites of pits 910, hence, confining the filler material to these locations, in other embodiments, filler material 912 is disposed on all surfaces of insulating material 908. Thus, in order to generate distinct, separate nanostructures of filler material 914, it may be necessary to perform additional processing to confine filler material 912 to pits 910 during the formation of nanostructures of filler material 914.

One exemplary method for confining filler material 912 to pits 910, is to anneal filler material 912, as shown in FIGS. 9G-91. By heating filler material 912 to a temperature greater than the filler material annealing temperature (e.g., for at least 2 minutes, at least 5 minutes, at least 10 minutes, or at least 20 minutes), filler material 912 is able to migrate into (e.g., flow), and be confined to, pits 910. As shown in FIG. 9G (same view as FIG. 9E following deposition of filler material 912), filler material 912 initially present both in pits 910, and on insulating material 908 on pillars 904, migrates into pits 910 in FIG. 9H as the filler material is annealed, and then is ultimately confined to pits 910, thereby forming individual, distinct, separate nanostructures of filler material 914 (e.g., magnetic material), separated by insulator material 908, as shown in FIG. 9I.

In further embodiments, disposing step 810 can comprise depositing a filler material onto insulator layer 908, followed by subsequently removing a portion of filler material 912 and a portion of insulator material 908, as shown in FIGS. 9J-9L. Filler material 912 can also be annealed following depositing of the material, but prior to removal of a portion of the material. Filler material can be deposited using any of the exemplary methods described throughout or otherwise known in the art, for example, by chemical vapor deposition, physical vapor deposition or evaporation.

As discussed above, it is desirable to produce individual, separate, distinct nanostructures of filler (magnetic) material 914 separated by insulator material 908. Following depositing of filler material 912 (FIG. J, same as FIG. 9E), a portion of the filler material, as well as a portion of insulator layer can be removed, as shown in FIG. 9K. For example, filler material 912 and insulator material 908 can be removed by mechanical polishing or by etching, including isotropic and anisotropic etching, for example, using RIE or electron beam etching. Suitably, at least all of filler material 912 above or on top of substrate pillars 904 is removed (e.g., etched), while at least some of the filler material 912 in pits 910 is not removed (e.g., etched). Thus, as shown in FIGS. 9K-9L, filler material 912 that was deposited on top of substrate pillars 904 is suitably etched such that all of this material is removed. Further removal, e.g., etching, into the surface of insulator material 908 that was grown on substrate pillars 904, while removing some of filler material 912 present in pits 910, forms individual, separated filler material nanostructures 914 surrounded by insulator material 908, as shown in FIG. 9L.

As discussed above, the ability to tightly control the center-to-center distance between adjacent masking nanoparticles provides the ability to prepare pits that are between about 1-10 nm in size, or about 1-5 nm in size. Thus, filler material nanostructures 914 generated by filling in pits 910 with filler material 912 are also prepared in this size range, e.g., between about 1-10 nm in diameter (about 3-10 nm), or between about 1-5 nm in diameter.

In further embodiments, the present invention provides a plurality magnetic nanostructures (e.g., nanoparticles) having specified characteristics. For example, in suitable embodiments, the nanostructures comprise diameters between about 1 nanometer and about 10 nanometers, or about 3 nm to about 10 nm, with size distributions no greater than about 15% of a mean diameter of the nanostructures. In further embodiments, the plurality of nanostructures comprise center-to-center spacings between adjacent nanostructures that are between about 1 nanometer and about 10 nanometers, where the center-to-center spacing is controlled to comprise a variance of about 10%. Suitably, the nanoparticles are separated from their nearest neighbor nanoparticles by less than about 10 nm, for example, less than about 5 nm, less than about 1 nm, or suitably, on the order of a few to 10s of Å.

As discussed throughout, the masking nanoparticles of the present invention comprise highly uniform diameters and are deposited in such a way that the center-to-center spacing between adjacent masking nanoparticles can be controlled to a very high degree. Preparing nanostructures using the various methods described throughout using these masking nanoparticles translates to nanostructures that also have very uniform diameters and center-to-center spacings. Thus, in suitable embodiments the diameters of the nanostructures are between about 1-20 nm, suitably between about 1-15 nm, about 1-10 nm, about 3-10 nm, or about 1-5 nm, e.g., about 2 nm, about 3 nm, about 4 nm, about 5 nm, about 6 nm, about 7 nm, about 8 nm, about 9 nm, or about 10 nm. Suitably, the size distributions of the nanostructures produced by the methods of the present invention are no greater than about 30% of a mean diameter of the nanostructures, and suitably, no greater than about 20%, no greater than about 15%, no greater than about 12%, no greater than about 10%, no greater than about 8%, no greater than about 6%, or no greater than about 5%. As used herein, the phrase “size distributions” as it relates to the diameter of the nanostructures and/or masking nanoparticles means that diameters of the nanostructures/masking nanoparticles are within a specified percentage (e.g, 20% greater or 20% less than) of the mean diameter of the population of nanostructures/masking nanoparticles.

In addition, the center-to-center spacing between adjacent nanostructures is suitably between about 1-20 nm, suitably about 1-15 nm, about 1-10 nm, or about 1-5 nm, e.g., about 2 nm, about 3 nm, about 4 nm, about 5 nm, about 6 nm, about 7 nm, about 8 nm, about 9 nm, or about 10 nm. Suitably, the center-to-center spacing is controlled to comprise a variance of about 10%, for example, between about 5-20%, about 7-15% or about 8-12%. As used herein, the phrase “variance” as it relates to the center-to-center spacing between adjacent nanostructures and/or masking nanoparticles means that the center-to-center spacings between nanostructures/masking nanoparticles are within a specified percentage (e.g, 20% greater or 20% less than) of the mean center-to-center spacings of the population of nanostructures/masking nanoparticles. In exemplary embodiments, the nanoparticles are separated from their nearest neighbor nanoparticles by less than about 10 nm, for example, less than about 5 nm, less than about 1 nm, or suitably, on the order of a few to 10s of Å.

As discussed throughout, the magnetic nanostructures of the present invention are suitably used in various magnetic storage media or recording media. In embodiments, magnetic nanostructures can be generated directly on the desired final substrate, e.g., a glass substrate, and then incorporated into the various devices. In other embodiments, the nanostructures can be harvested or removed from the substrate, and then incorporated into the various media and devices. Suitably, the magnetic moment of the storage media or recording media prepared using the various nanostructures described herein is oriented out of the plane of the nanostructures, e.g., normal to a support substrate.

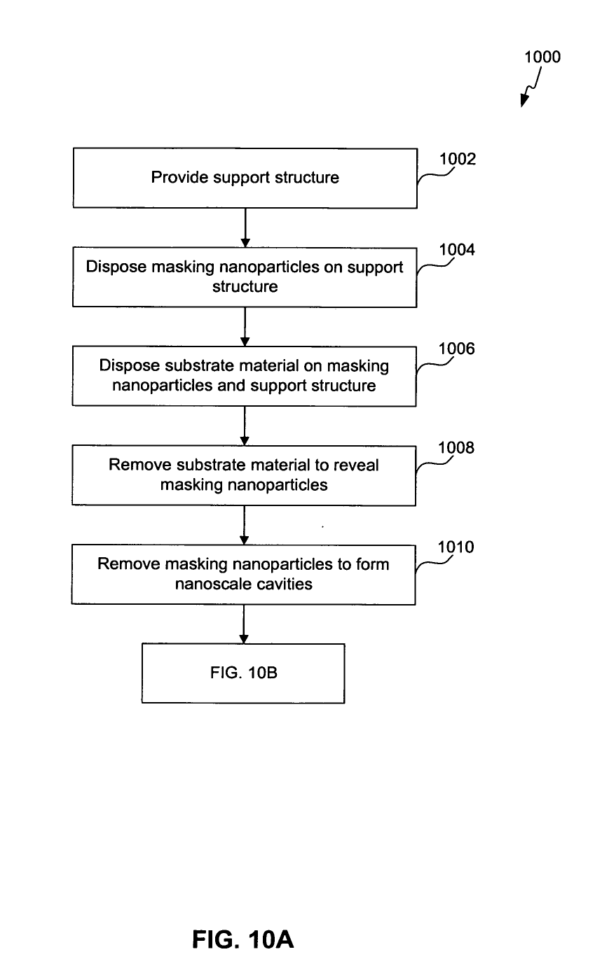

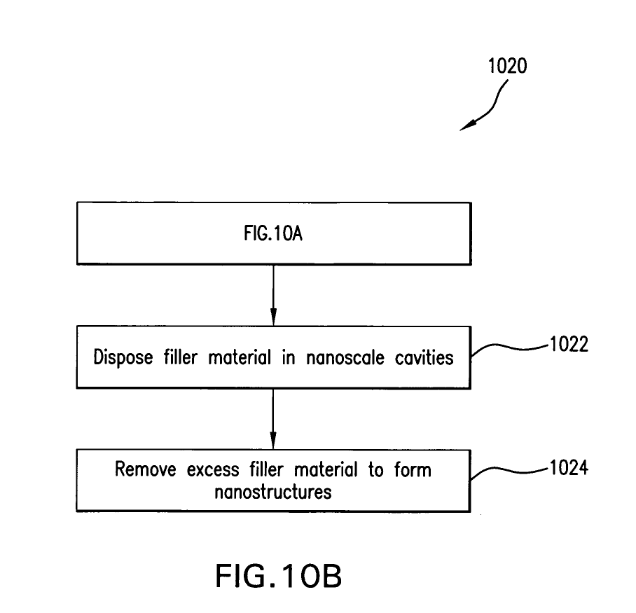

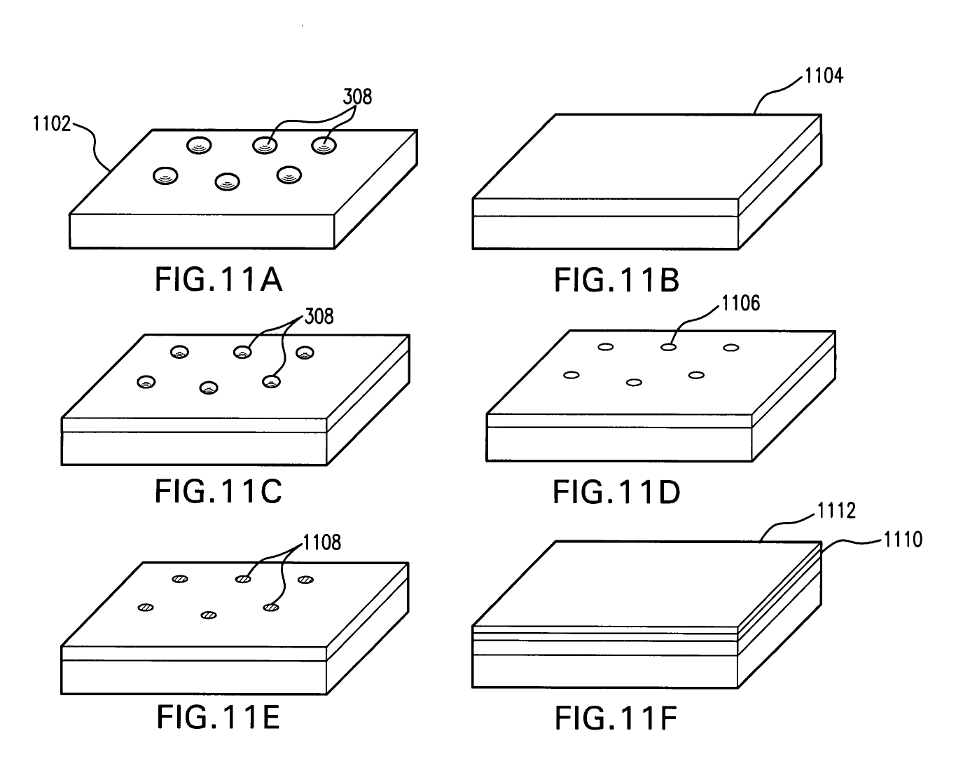

The present invention also provides further methods of generating nanoscale cavities, and nanoscale cavities generated by such methods, which can then be filled with filler material, such as a magnetic material. Exemplary embodiments are illustrated in flowchart 1000 of FIG. 10A with reference to FIGS. 11A-11F. As shown in step 1002 of FIG. 10A, a support structure 1102 is provided. Support structure 1102 can comprise any suitable material, including metals, semiconductors, polymers, insulators, etc.

In step 1004 of flowchart 1000, one or more masking nanoparticles 308 are disposed on support structure 1102, as shown in FIG. 11A. Exemplary methods for disposing masking nanoparticles (e.g., spin-coating, spray-coating, or dip-coating), as well as types and sizes (e.g., about 1-10 or about 1-5 nm) of masking nanoparticles for use in the practice of the present invention are described throughout. In step 1006 of flowchart 1000, a substrate material 1104 is then disposed on masking nanoparticles 308 and support structure 1102, thereby covering masking nanoparticles 308, as shown in FIG. 11B. As represented in FIG. 11B, substrate 1104 suitably completely covers masking nanoparticles 308. While substrate 1104 is represented as a substantially flat layer of disposed material, in many cases, small mounds or variations in substrate 1104 may occur where the substrate is covering masking nanoparticles 308. Exemplary substrate materials 1104 include electrically conducting materials, dielectric materials, semiconductor materials, insulators and the like. For example, substrate material 1104 can comprise silicon dioxide or alumina. Methods for disposing substrate material 1104 in step 1006 include spray coating, layering, physical vapor deposition, chemical vapor deposition, evaporation and the like.

In step 1008 of FIG. 10A, at least a portion of substrate material 1104, is then removed, thereby revealing at least a portion of masking nanoparticles 308, as shown in FIG. 11C. Exemplary methods for removing substrate 1104 include, but are not limited to physical methods, such as chemical, mechanical or chemical-mechanical polishing and planing, as well etching as described throughout, including various chemical etching methods, as well as RIE etching and electron beam etching. Suitably, removal step 1008 is performed by a mechanical or chemical-mechanical process, such as polishing or planing. U.S. Pat. No. 5,527,423, for example, (the disclosure of which is incorporated by reference herein in its entirety) describes a method for chemically-mechanically polishing a metal layer by contacting the surface with a polishing slurry comprising high purity fine metal oxide particles in an aqueous medium. The polishing slurry is typically used in conjunction with a polishing pad (e.g., polishing cloth or disk). Suitable polishing pads are described in U.S. Pat. Nos. 6,062,968, 6,117,000, and 6,126,532 (the disclosures of which are incorporated by reference herein in their entireties), which disclose the use of sintered polyurethane polishing pads having an open-celled porous network, and U.S. Pat. No. 5,489,233 (the disclosure of which is incorporated by reference herein in its entirety), which discloses the use of solid polishing pads having a surface texture or pattern. Alternatively, the abrasive material may be incorporated into the polishing pad. U.S. Pat. No. 5,958,794 (the disclosure of which is incorporated by reference herein in its entirety) discloses a fixed abrasive polishing pad.

Removing at least a portion of substrate 1104 so as to reveal at least a portion of masking nanoparticles 308 provides access to masking nanoparticles 308, while still maintaining substrate material 1104 surrounding the nanoparticles. Then, in step 1010 of flowchart 1000, masking nanoparticles 308 are removed. As shown in FIG. 11D, removal of masking nanoparticles 308 forms nanoscale cavities 1106 in substrate 1104 at the sites once occupied by the masking nanoparticles 308. By selectively removing just the masking nanoparticles 308, but not removing or otherwise substantially impacting substrate 1104, cavities 1106 are left in substrate 1104 where the masking nanoparticles 308 were. Selective removal of masking nanoparticles 308 in step 1010 requires selection of a proper removal method, for example, a selective etch that removes masking nanoparticles 1104, but does not substantially impact substrate 1104. Exemplary methods of etching, including chemical, RIE and electron beam etching, are described throughout. While it is desirable to not remove any substrate 1104 during step 1010, removal of some substrate material is acceptable, and may allow for the formation of larger nanoscale cavities in substrate 1104.

As discussed throughout, the size of masking nanoparticles is suitably between about 1-20 nm, about 1-10 nm (or about 3-10 nm), or about 1-5 nm. Thus, the method shown in flowchart 1000 suitably generates nanoscale cavities 1106 that are between about 1-20 nm, about 1-10 nm, about 3-10 nm, or about 1-5 nm, as it is the diameter of the masking nanoparticles that ultimately determines the size of nanoscale cavities 1106. As discussed above, the depth of nanoscale cavities 1106 is controlled by the extent of removal/etch of substrate 1104. In suitable embodiments, substrate 1104 is removed down to the level of support layer 1102.

In still further embodiments, the present invention provides methods for generating one or more nanostructures utilizing nanoscale cavities 1106. Following the formation of nanoscale cavities in a substrate 1104 as shown in FIG. 10A, one or more nanostructures can be prepared using these nanoscale cavities 1106, as shown in flowchart 1020 of FIG. 10B. For example, in step 1022, a filler material (e.g., a magnetic material) is disposed in the nanoscale cavities 1106, as shown in FIG. 11E. Then, any excess filler material that is above the plane of the substrate material 1102 is removed in step 1024, thereby forming one or more nanostructures 1108 in the nanoscale cavities 1106. Suitable methods for disposing filler material in the nanoscale cavities 1106 are described throughout, including chemical vapor deposition, physical vapor deposition and evaporation. Exemplary filler materials include the magnetic materials described throughout. Methods for removing excess filler material are also described throughout, including various forms of planing and/or etching.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

All publications, patents and patent applications mentioned in this specification are herein incorporated by reference to the same extent as if each individual publication, patent or patent application was specifically and individually indicated to be incorporated by reference.

1. A method for generating one or more nanostructures of a magnetic material, comprising:
(a) disposing one or more masking nanoparticles on a magnetic substrate material, wherein the nanoparticles cover at least a portion of the substrate at a site;
(b) removing uncovered magnetic substrate material, thereby forming magnetic substrate nanostructures at the site of the masking nanoparticles; and
(c) removing the masking nanoparticles.

2. The method of claim 1, wherein the disposing is on a magnetic substrate alloy that comprises one or more of Fe, Co, Ni, Pt, Cr, B, C, and Al, and mixtures of such alloys.

3. The method of claim 1, wherein the disposing is on a magnetic substrate alloy that comprises CoCrPt.

4. The method of claim 1, wherein the disposing comprises spin-coating, dip-coating, or spray-coating the masking nanoparticles.

5. The method of claim 4, wherein the coating comprises coating Pd, Ni, Ru, Co, Au or SiO₂ nanoparticles.

6. The method of claim 1, wherein the removing in (b) comprises etching the magnetic substrate material, but not the masking nanoparticles.

7. The method of claim 6, wherein the etching comprises anisotropically etching the magnetic substrate material.

8. The method of claim 7, wherein the etching comprises reactive ion etching or electron beam etching.

9. The method of claim 1, wherein the removing the masking nanoparticles in (c) comprises rinsing the substrate surface with a solution.

10. The method of claim 1, wherein the disposing comprises disposing masking nanoparticles that are between about 1-20 nm in diameter, and wherein the nanostructures that are generated are between about 1-20 nm in diameter.

11. The method of claim 1, wherein the disposing comprises disposing masking nanoparticles that are between about 1-10 nm in diameter, and wherein the nanostructures that are generated are between about 1-10 nm in diameter.

12. The method of claim 1, wherein the disposing comprises disposing masking nanoparticles less than about 5 nm apart, and wherein the nanostructures that are generated are less than about 5 nm apart.

13. A method for generating one or more nanostructures of a magnetic material, comprising:
(a) forming one or more nanoscale cavities in a substrate material by:
(i) disposing a negative-resistant layer on the substrate;
(ii) disposing one or more masking nanoparticles on the negative-resistant layer, wherein the nanoparticles cover at least a portion of the negative-resistant layer;
(iii) reacting one or more uncovered portions of the negative-resistant layer to form one or more etch masks comprising one or more portions of reacted negative-resistant layer and one or more portions of un-reacted negative-resistant layer;
(iv) removing the masking nanoparticles, thereby revealing the one or more portions of un-reacted negative-resistant layer;
(v) removing the un-reacted portions of the resistant layer, thereby revealing one or more exposed substrate sections; and
(vi) removing at least a portion of the one or more exposed substrate sections, thereby forming nanoscale cavities in the substrate;
(b) disposing a magnetic material in the nanoscale cavities; and
(c) removing excess magnetic material that is above the plane of the substrate, thereby forming one or more nanostructures in the nanoscale cavities.

14-29. (canceled)

30. A method for generating one or more nanostructures of a magnetic material, comprising:
(a) disposing one or more masking nanoparticles on a substrate, wherein the nanoparticles cover at least a portion of the substrate;
(b) removing uncovered substrate material, thereby forming substrate pillars at the portion of the substrate covered by the masking nanoparticles, and forming substrate cavities at a portion of the substrate not covered by the masking nanoparticles;
(c) removing the masking nanoparticles;
(d) disposing an insulating layer on the pillars and at least partially in the cavities, wherein a pit is maintained at the site of the cavities; and
(e) disposing a magnetic material on the insulating layer, wherein the magnetic material forms nanostructures confined to the pits.

31-59. (canceled)

60. A magnetic nanostructure of a magnetic recording medium produced by a process comprising:
(a) disposing one or more masking nanoparticles at a site on a magnetic substrate material, wherein the nanoparticles cover at least a portion of the substrate;
(b) removing uncovered substrate material, thereby forming substrate nanostructures at the sites of the masking nanoparticles; and
(c) removing the masking nanoparticles.

61. A magnetic nanostructure of a magnetic recording medium produced by a process comprising:
(a) disposing a negative-resistant layer on a substrate;
(b) disposing one or more masking nanoparticles on the negative-resistant layer, wherein the nanoparticles cover at least a portion of the layer;
(c) reacting one or more uncovered portions of the negative-resistant layer resistant to form one or more etch masks thereby forming one or more portions of reacted negative-resistant layer and one or more portions of un-reacted resistant layer;
(d) removing the masking nanoparticles, thereby revealing the one or more portions of un-reacted negative-resistant layer;
(e) removing the un-reacted portions of the resistant layer, thereby revealing one or more exposed substrate sections;
(f) removing at least a portion of the one or more exposed substrate sections, thereby forming nanoscale cavities in the substrate;
(g) disposing a magnetic material in the nanoscale cavities; and
(h) removing excess magnetic material that is above the plane of the substrate, thereby forming one or more nanostructures in the nanoscale cavities.

62. A magnetic nanostructure of a magnetic recording medium produced by a process comprising:
(a) disposing one or more masking nanoparticles on a substrate, wherein the nanoparticles cover at least a portion of the substrate;
(b) removing uncovered substrate material, thereby forming substrate pillars at the portion of the substrate covered by the masking nanoparticles, and forming substrate cavities at a portion of the substrate not covered by the masking nanoparticles;
(c) removing the masking nanoparticles;
(d) disposing an insulating layer on the pillars and at least partially in the cavities, wherein a pit is maintained at the site of the cavities; and
(e) disposing a magnetic material on the insulating layer, wherein the magnetic material forms nanostructures confined to the pits.

63. A plurality of magnetic nanostructures, wherein:
the nanostructures comprise diameters between about 1 nanometer and about 20 nanometers;
the nanostructures comprise diameters with size distributions no greater than about 15% of a mean diameter of the nanostructures;
a center-to-center spacing between adjacent nanostructures is less than about 10 nanometers; and
a center-to-center spacing between adjacent nanostructures is controlled to comprise a variance of about 10%.

64-65. (canceled)

66. A method for generating one or more nanostructures of a magnetic material, comprising:
(a) forming one or more nanoscale cavities in a substrate material by:
(i) providing a support structure;
(ii) disposing one or more masking nanoparticles on the support structure;
(iii) disposing a substrate material on the masking nanoparticles and the support structure, thereby covering the masking nanoparticles;
(iv) removing at least a portion of the substrate material, thereby revealing at least a portion of the masking nanoparticles; and
(v) removing the masking nanoparticles, thereby forming nanoscale cavities in the substrate material; and
(b) disposing a magnetic material in the nanoscale cavities; and
(c) removing excess magnetic material that is above the substrate material, thereby forming one or more nanostructures in the nanoscale cavities.

67-88. (canceled)
